(19) United States
(12) Patent Application Publication
(10) Pub. No.: US 2023/0313718 A1
(43) Pub. Date: Oct. 5, 2023

(54) OIL DECANTATION SYSTEM FOR AN INTERNAL COMBUSTION ENGINE

(71) Applicant: NOVARES FRANCE, Clamart (FR)

(72) Inventors: Jérôme DEMANGEOT, Calonne Sur La Lys (FR); Romain POCQUET, Bertincourt (FR); Gilles WAYMEL, Hulluch (FR)

(21) Appl. No.: 17/614,950

(22) PCT Filed: May 28, 2020
(86) PCT No.: PCT/FR2020/050905

§ 371 Date: Apr. 20, 2022

(30) Foreign Application Priority Data
May 29, 2019 (FR) 19/05794

(51) Int. Cl. F01M 13/04

(52) U.S. Cl. CPC F01M 13/04; F01M 2013/0044

(57) ABSTRACT

An oil decantation system for an internal combustion engine includes at least one main wall provided with a through-opening for a flow of blow-by gas and a separator device arranged downstream of said through-opening in the direction of travel of said flow of blow-by gas. The separator device includes a valve provided with a decantation component capable of retaining the oil contained in the blow-by gas and of allowing a flow of purified blow-by gas to pass through, wherein the valve is pivotably mounted on the main wall so that its inclination with respect to the main wall varies as a function of the flow of blow-by gas.

### TECHNICAL FIELD

The present disclosure concerns an oil decantation system for an internal combustion engine.

### BACKGROUND

During its operation, an internal combustion engine produces “blow-by” gases or crankcase gases, i.e. gases which are confined in the engine casing. These gases are produced during normal operation of the engine. The phenomenon of “blow-by” appears when gases pressurized during the compression phase escape through the passages formed between the segments and the liners, the valve guides, the bearings to end up in the casing where they mix with the oil vapors. This phenomenon is accentuated with the wear of segments and the liners.

The blow-by gases should be evacuated from the casing so as not to overpressure the latter and so as not to go back up into the combustion chambers where their combustion turns out quite deleterious in terms of emission of toxic particles.

As the blow-by gases are loaded with oil droplets, they may not be released into the atmosphere; this is prohibited by the applicable anti-pollution standards. The blow-by gases are therefore reintroduced to the air intake after having been purged of the oil droplets with which they are loaded.

It is important that the cleaning operation of the gases should be as efficient as possible for at least three reasons.

The introduction of blow-by gases loaded with oil to make them burn in the cylinders increases the emission of toxic particles. This deteriorates the efficiency of the engine and, finally, it increases the oil consumption of the engine.

For this purpose, there are separation devices that clean the blow-by gases by trapping the oil droplets; these separation devices may act by decantation.

An oil separation device operating by decantation is known, for example, from the document FR-A-2984175. In this prior art, a solution is in particular proposed to the problem of pressure losses when the engine speed increases. To this end, it has been considered to equip the oil separation device with an obstruction member movable under the effect of the pressure exerted by the upstream gas flow, the obstruction member returning to its rest position under the effect of spring-type return means.

However, the solution described in this prior art has the drawback of requiring a spring so as to bring the obstruction member back to its rest position. This solution is therefore relatively complex to implement and, moreover, results in a non-negligible increase in the manufacturing cost.

### SUMMARY

In this technical context, an aim of the disclosure is to provide an oil decantation system which does not have the drawbacks of the aforementioned prior art.

The disclosure concerns an oil decantation system for an internal combustion engine comprising at least one main wall provided with a passage opening for a flow of blow-by gas and a separation device disposed downstream of said passage opening in the direction of circulation of said flow of blow-by gas, the separation device comprising a valve provided with decantation means capable of retaining the oil contained in the blow-by gas and of letting a flow of purified blow-by gas pass, characterized in that the valve is pivotally mounted on the main wall such that its inclination relative to said main wall varies as a function of the flow of blow-by gas.

Thus, the disclosure proposes an oil decantation device which makes it possible to adapt the inclination of the valve to the flow of blow-by gas. As a result, when the flow rate of the flow of blow-by gas increases upstream, it generates a greater inclination of the valve relative to the main wall, which makes it possible to evacuate downstream a greater flow rate of gas. The solution of the disclosure therefore offers the same advantages as the solution described above while avoiding the use of a spring to bring the valve back to its rest position.

According to several features of the disclosure considered individually or in combination:
the valve is movable between a closure position in which its angle of inclination relative to the main wall is zero, the flow of blow-by gas circulating only throughout the decantation means of the valve, and an opening position in which its angle of inclination relative to the main wall is non-zero, the flow of blow-by gas circulating partly throughout the decantation means of the valve and partly throughout a passage section formed between the main wall and the valve.
the valve is held in the closure position by gravity.
the valve comprises a first end pivotally connected on the main wall and a second end substantially parallel to said first end.
the valve comprises an element intended to act as a counterweight, said element being disposed at the level of the second end.
the system comprises a flexible screen structure extending from the second end of the valve and arranged such that, in the opening position of the valve, the flow of blow-by gas circulating through the passage section formed between the main wall and the valve passes at least partially through said screen structure, said screen structure thus being able to retain the oil contained in said flow of blow-by gas and to let a flow of purified blow-by gas pass.
The system comprises stop means capable of limiting the angle of inclination of the valve relative to the main wall.
The stop means are configured to elastically absorb shocks.
the valve is configured to have a non-zero angle of inclination with respect to the main wall when the flow rate of the flow of blow-by gas at the level of the opening is high enough to open said valve and is, for example, greater than 20 L/min.

### BRIEF DESCRIPTION OF THE DRAWINGS

According to another aspect, the disclosure concerns an internal combustion engine comprising a decantation system as described before.

The disclosure will be better understood upon reading the following non-limiting description, referring to the appended figures.

FIG. 1 schematically represents an engine equipped with a decantation system according to the disclosure.

FIG. 2 is a top perspective view of a cylinder head cover incorporating a decantation system according to the disclosure.

FIG. 3 is a view similar to FIG. 2, an outer wall of the cylinder head cover having been removed so as to see the interior of the decantation system;

FIG. 4 is a perspective view of the valve equipping the decantation system represented in FIG. 3;

FIG. 5 is a front view of the valve represented in FIG. 4;

FIG. 6 is a perspective view of the main wall of the decantation system on which is articulated the valve represented in FIG. 4;

FIG. 7 is a side view in cross section of the detail A of FIG. 3, the valve being in its closure position;

FIG. 8 is a view similar to FIG. 7, the valve being in an opening position;

FIG. 9 is a view similar to FIG. 8, the valve being provided with a counterweight;

FIG. 10 is a view similar to FIG. 8, an inner wall of the cylinder head cover being provided with a stop element;

FIG. 11 is a view similar to FIG. 8, the valve being provided at its free end with a sieve structure;

FIG. 12 is a cross-sectional view according to the section plane P1 represented in FIG. 3;

FIG. 13 is a graph showing the evolution of the pressure differential between the outside and the inside of the decantation case as a function of the flow rate of gas flow for several embodiments of the decantation system.

### DETAILED DESCRIPTION OF THE DRAWINGS

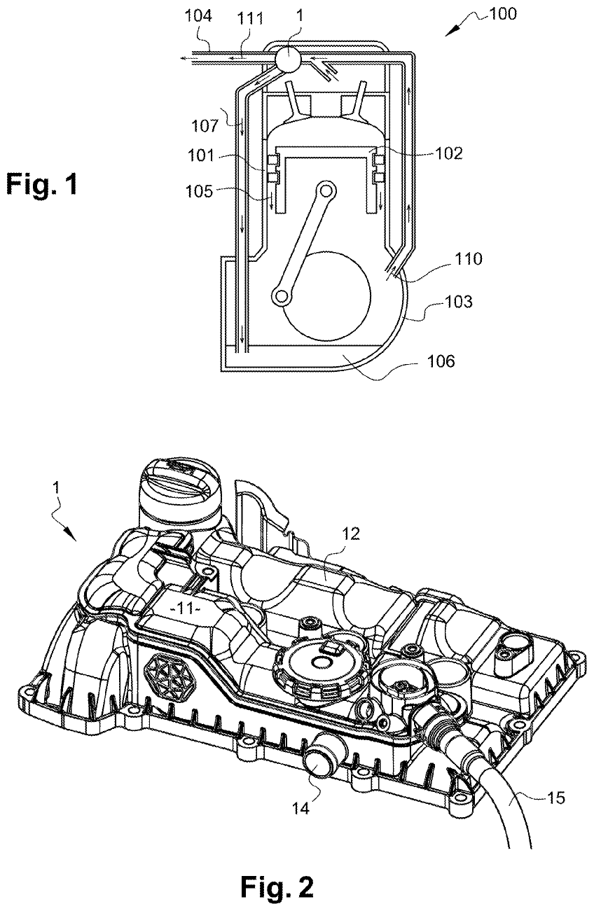

Schematically, an internal combustion engine 100 as represented in FIG. 1 comprises in particular a cylinder 101 in which moves a piston 102, a sump 103 in which oil 106 is bubbling, and a suction duct 104. During the operation of the engine, the burnt gases 105 seep in the oil sump 103 by passing between the cylinder 101 and the piston 102 throughout the segmentation. Their evacuation causes a so-called blow-by gas flow 110 loaded with oil droplets collected during the bubbling in the oil 106.

The engine 100 is equipped with an oil decantation system 1 according to the disclosure.

The blow-by gases 110 are routed to the inlet of the oil decantation system 1 according to the disclosure, the latter making it possible to clear the flow of blow-by gas 110 of the oil droplets that it contains. The trapped oil droplets 107 are collected and routed to the oil sump 103 for recycling. The gas flow 111 cleared of oil droplets, hereinafter referred to as the purified blow-by gas flow, is evacuated into the air suction duct 104 of the engine. This gas flow 111 generally has a very small, if any, remaining amount of oil.

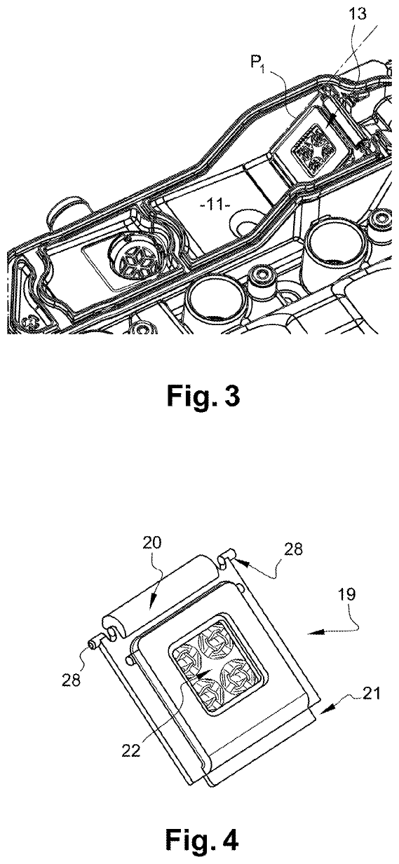

Referring to FIGS. 2 and 3, the oil decantation system 1 according to the disclosure comprises a decantation case 11 forming a single block with a cylinder head cover 12 of an internal combustion engine. This decantation case 11 comprises in particular an inlet area 13 for the flow of blow-by gas coming from the engine casing, a first outlet orifice 14 for the evacuation of the oil recovered from the blow-by gases and a second outlet orifice 15 for the evacuation of purified blow-by gases.

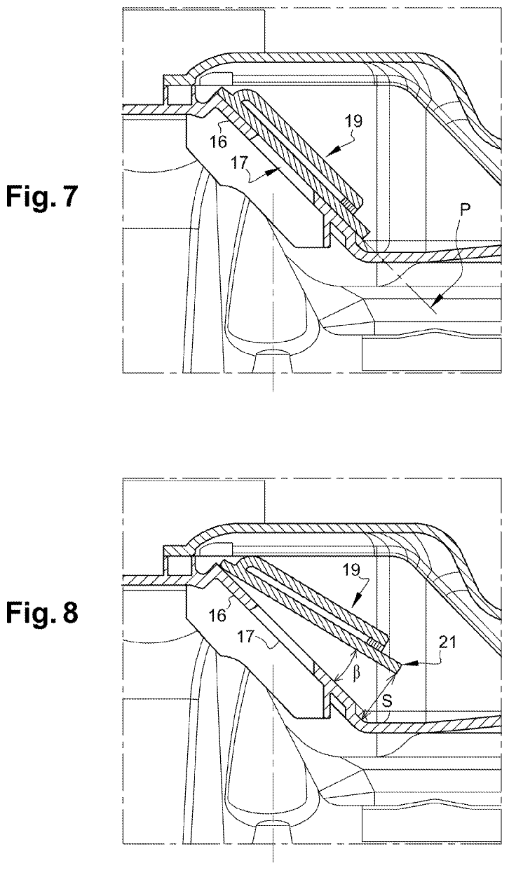

As represented in FIGS. 4 to 6, the inlet area 13 is formed by a main wall 16 provided with a passage opening 17, the decantation case 11 being in fluid communication with the interior of the engine casing through said passage opening 17. The main wall 16 is advantageously arranged obliquely relative to a secondary wall 18 of the decantation case 11 such that, during normal operation of the engine, the secondary wall 18 is oriented vertically and the main wall 16 is inclined at an angle α with respect to the vertical. A valve 19 is articulated on the main wall 16 such that it could pivot about an axis XX′ at the level of one of its ends 20 between a first position, as represented in FIG. 7, in which it rests on the main wall 16, and a second position, as represented in FIG. 8, in which it is inclined at a non-zero angle β with respect to the main wall 16. The passage from the first position, called the closure position, into the second position, called the opening position, will depend on the flow of blow-by gas. In particular, the flow of blow-by gas exerts on the valve 19 a thrust directed upward and according to a direction substantially perpendicular to the plane P defined by the main wall 16. This thrust is proportional in particular to the flow rate of the flow of blow-by gas. As long as this thrust is low, that is to say as long as the flow rate of the gas flow is low, it is not sufficient to counter the weight of the valve 19: the valve 19 therefore remains resting against the main wall 16. Conversely, when the flow rate of the gas flow exceeds a threshold value Dmin, which depends in particular on the weight of the valve 19 and the angle of inclination α, it generates sufficient thrust to lift the valve 19: the valve 19 is no longer resting against the main wall 16 and the blow-by gas may therefore escape through the passage section S formed between the free end 21 of the valve 19 and the main wall 16. This configuration therefore makes it possible to solve the problem of pressure drops due to overpressure in the engine casing. Moreover, this configuration has the advantage of not requiring return means to return the valve 19 to its closure position, given that the valve 19 automatically returns to its closure position under the effect of gravity. During normal operation of the engine, the valve 19 will thus be constantly subjected to an upward thrust force exerted by the flow of blow-by gas and to a downward force of attraction due to its weight. It will thus tend to oscillate around an average position depending on the level of use of the engine.

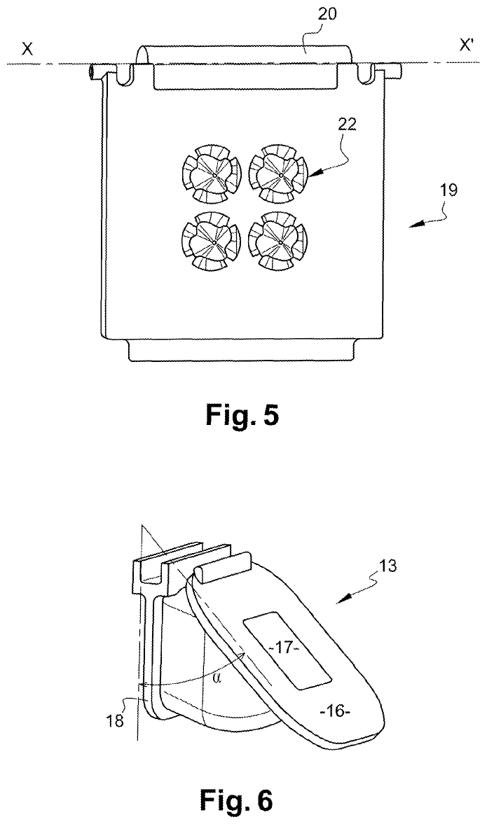

The valve 19 is provided with decantation means 22, said decantation means 22 being configured to extract the oil contained in the blow-by gas. Several possible configurations may be considered at this level. Thus, in the configuration represented in FIGS. 4 and 5, the decantation means 22 consist of a series of fixed propellers disposed inside through openings formed in the wall of the valve 19. The operation and the structural details of such fixed propellers have in particular been described in the patent EP 1 684 888. Another possible configuration could consist in using propellers having at least one movable flap. Such a configuration has in particular been described in the patent EP 2 050 491. A third possible configuration could consist in disposing a porous fiber-based material in a central through-opening of the valve 19. Regardless of the configuration used, the valve 19 provided with said retention means 22 thus allows letting a flow of purified blow-by gas pass inside the decantation case 11.

Of course, the volume of purified blow-by gas leaving the decantation case 11 will be greater when the valve 19 is in its closure position given that, in this closure position, all the amount of the gas flow enters via the passage opening 17 and the decantation means 22. On the contrary, when the valve 19 is in the opening position, portion of the gas flow enters the decantation case 11 via the passage section S and is therefore not purified by the decantation means 22.

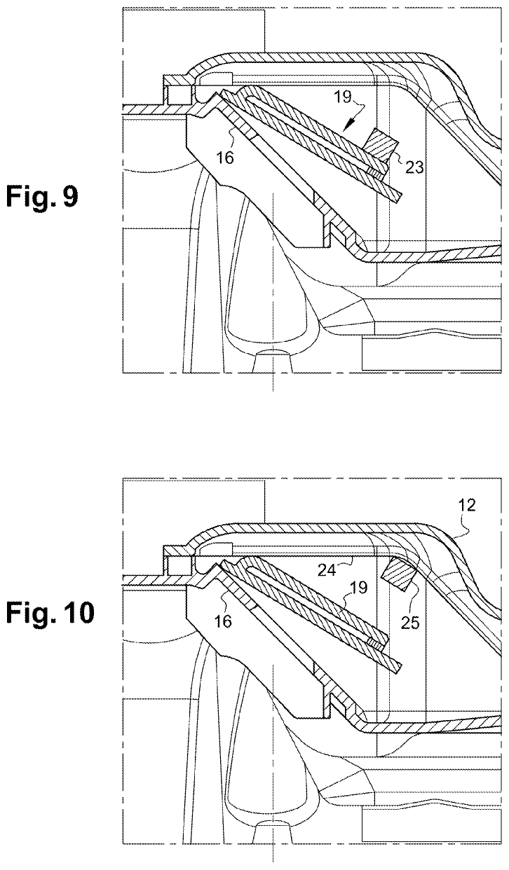

Referring to FIG. 9, there is represented a first possible variant of the disclosure. In this variant, the valve 19 comprises a counterweight 23 disposed near its free end 21. This counterweight 23 will make the valve 19 heavier, thus increasing the downward attraction force to which it is subjected. This results in a concomitant increase in the threshold value Dmin of the flow rate of the flow of blow-by gas from which the valve 19 begins to rise under the effect of the thrust exerted by the gas flow upstream of the valve 19.

Referring to FIG. 10, a second possible variant of the disclosure is represented. In this variant, an inner wall 24 of the cylinder head cover 12 is provided with a stop element 25, said stop element 25 being disposed so as to limit the pivoting of the valve 19 about its end 20. This stop element 25 will thus prevent a very large opening of the valve 19, and, therefore, will limit the risk of direct impacts between the valve 19 and the inner wall 24. Advantageously, it is possible to use an elastic material absorbing shocks to form the stop element 25 so that direct impacts of the valve 19 against the stop element 25 do not lead to damage or destruction of the valve 19. In another configuration of the disclosure, a shock absorbing element could also be integrated into the valve 19 itself. This absorber element will be placed on the face of the valve 19 that is oriented towards the inner wall 24 of the cylinder head cover 12.

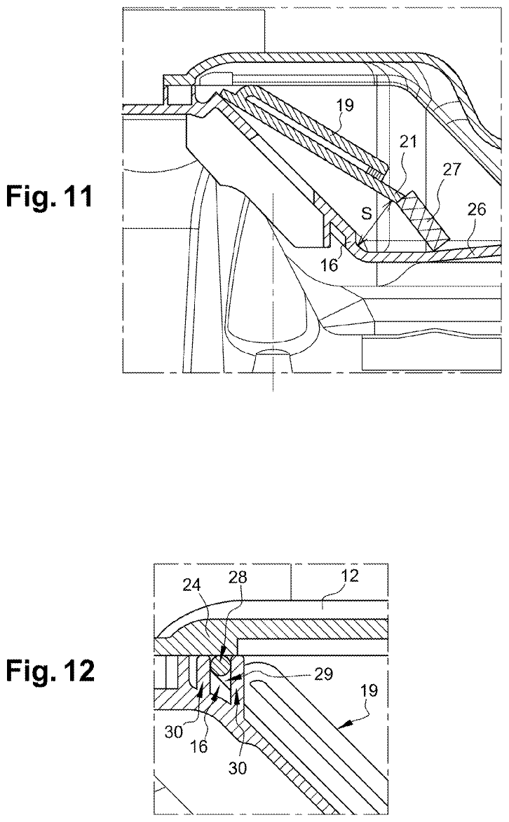

Referring to FIG. 11, a third possible variant of the disclosure is represented. In this variant, a flexible sieve structure 27 is fastened or secured to the free end 21 of the valve 19 and extends between this free end 21 and a bottom wall 26 of the decantation case 11 which is contiguous to the main wall 16 such that, in the opening position of the valve, the free space between this free end 21 and this bottom wall 26 is at least partially obstructed by said sieve structure 27. In this way, the flow of blow-by gas flowing through the passage section S formed between the main wall 16 and the valve 19 at least partially passes through the sieve structure 27. This sieve structure 27 may advantageously be made of a porous material based on fibers. conferring the capacity to retain the oil contained in the blow-by gas. A flow of purified blow-by gas will thus be able to circulate downstream of the sieve structure 27 inside the decantation case 11.

Referring to FIG. 12, there is represented a structural detail of the valve 19 represented in FIGS. 4 and 5. This detail shows one of the possible technical solutions making it possible to achieve the pivoting fastening of the valve 19 on the main wall 16. In this solution, the end 20 of the valve 19 includes, on each side, a projecting tubular element 28, said tubular element 28 being intended to be housed in a space 29 delimited respectively, at the top and at the bottom, by the inner wall 24 of the cylinder head cover 12 and by the main wall 16 and, laterally, by two vertical ribs 30 of the decantation case 11. Thus disposed, the tubular elements 28 could pivot only inside the space 29, thus allowing the valve 19 to move in a pivoting manner between its closure position and one of its opening positions.

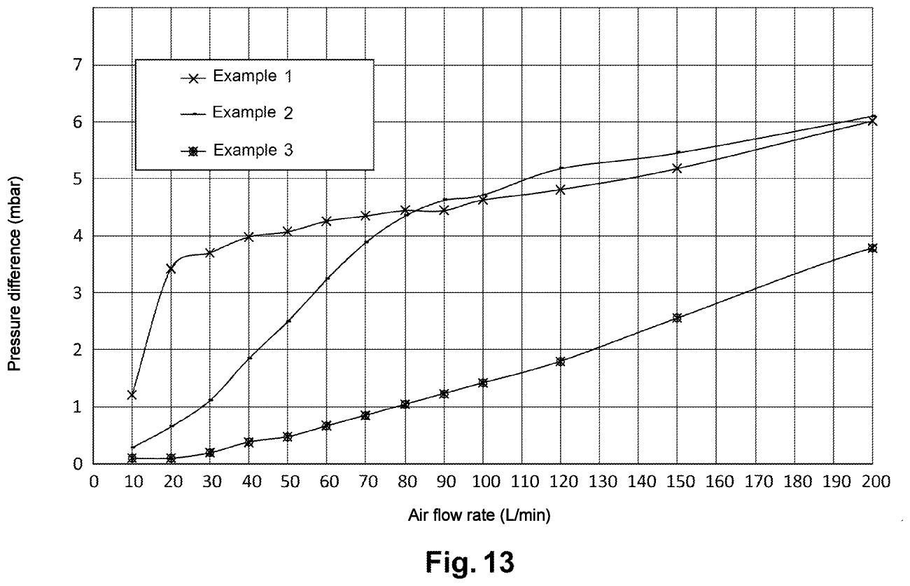

Referring to FIG. 13, there is represented a graph showing the evolution of the pressure differential between the outside and the inside of the decantation case 11 as a function of the flow rate of gas flow and that, for several embodiments of the decantation system 1.

In the embodiment of Example 1, the main wall 16 is inclined at 45° relative to the vertical. The passage opening 17 has a substantially square section covering an surface area of approximately 400 mm². The valve 19 also has a substantially square profile, the sides of which have a length of approximately 50 mm. The weight of the valve 19 is 50 g. It may be noticed on the graph that the curve flexes substantially when the flow rate of the gas flow exceeds 20 L/min. This value therefore corresponds to the threshold value Dmin from which the valve 19 rises under the effect of the pressure exerted by the flow of blow-by gas upstream of the valve 19. Indeed, when the valve 19 rises, the pressure differential between the outside and the inside of the decantation case 11 stops growing exponentially and then follows a relatively linear progression.

In the embodiment of Example 2, the dimensions of the valve 19, of the main wall 16 and of the passage opening 17, as well as the angle of inclination α, remain unchanged compared to Example 1. Conversely, the weight of the valve 19 is 20 g. It may be noticed on the graph that the curve flexes when the flow rate of the gas flow exceeds 85 L/min. This value corresponds to the above-mentioned threshold value Dmin.

In the embodiment of Example 3, the dimensions of the valve 19, of the main wall 16 and of the passage opening 17, as well as the angle of inclination α, remain unchanged compared to Example 1. Conversely, the weight of the valve 19 is 5 g. It may be noticed on the graph that the curve flexes when the flow rate of the gas flow exceeds 40 L/min. This value corresponds to the above-mentioned threshold value Dmin.

1. An oil decantation system for an internal combustion engine comprising at least one main wall provided with a passage opening for a blow-by gas flow and a separation device disposed downstream of said passage opening in the direction of circulation of said blow-by gas flow, the separation device comprising a valve provided with decantation means capable of retaining the oil contained in the blow-by gas and letting a flow of purified blow-by gas pass, wherein the valve is pivotally mounted on the main wall such that inclination of the valve relative to said wall main varies according to the flow of blow-by gas.

2. The decantation system according to claim 1, wherein the valve is movable between a closure position in which its angle of inclination of the valve relative to the main wall is zero, the flow of blow-by gas circulating only throughout the decantation means of the valve, and an opening position in which angle of inclination of the valve relative to the main wall is non-zero, the flow of blow-by gas circulating partly throughout the decantation means of the valve and partly through throughout a passage section formed between the main wall and the valve.

3. The decantation system according to claim 1, wherein the valve is held in the closure position by gravity.

4. The decantation system according to claim 1, wherein the valve comprises a first end pivotally connected on the main wall and a second end substantially parallel to said first end.

5. The decantation system according to claim 4, wherein the valve comprises an element configured to act as a counterweight, said element being disposed at the level of the second end.

6. The decantation system according to claim 2, further comprising a flexible screen structure extending from a second end of the valve and disposed such that, in the opening position of the valve, the flow of blow-by gas circulating through the passage section formed between the main wall and the valve at least partially passes through said screen structure, said screen structure thus being able to retain the oil contained in said blow-by gas flow and to let a purified blow-by gas flow pass.

7. The decantation system according to claim 1, wherein the decantation means of the valve comprises at least one fixed propeller disposed inside at least one through opening formed in the wall of the valve.

8. The decantation system according to claim 1, wherein the decantation system comprises stop means capable of limiting the angle of inclination of the valve relative to the main wall.

9. The decantation system according to claim 8, wherein the stop means are configured to elastically dampen shocks.

10. The decantation system according to claim 1, wherein the valve is configured to form a non-zero angle of inclination with the main wall when the flow rate of the flow of blow-by gas at the level of the opening is sufficiently large to open said valve.

11. The decantation system according to claim 10, wherein the valve is configured to form a non-zero angle of inclination with the main wall when the flow rate of the flow of blow-by gas at the level of the passage opening is greater than 20 L/min.

12. An internal combustion engine comprising a decantation system according to claim 1.
